(19) United States
(12) Patent Application Publication
(10) Pub. No.: US 2010/0141220 A1
(43) Pub. Date: Jun. 10, 2010

(54) SERIES ELECTRIC DOUBLE-LAYER CAPACITOR DEVICE

(75) Inventor: Shigeru Abe, Saitama City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NATIONAL UNIVERSITY CORPORATION SAITAMA UNIVERSITY, Saitama City, Saitama (JP)

(21) Appl. No.: 11/997,517

(22) PCT Filed: Jul. 14, 2006
(86) PCT No.: PCT/JP2006/314085

§ 371 Date: Feb. 25, 2010

(30) Foreign Application Priority Data
Aug. 1, 2005 (JP) 2005-222496

(51) Int. Cl. H02J 7/02

(52) U.S. Cl. 320/167

(57) ABSTRACT

[Problems] To provide a series electric double-layer capacitor device having a simple structure eliminating nonuniform voltages induced among electric double-layer capacitors (C1 to C6).

[Means for Solving Problems] A series electric double-layer capacitor device comprises 2n capacitors (C1 to C6), 2n diodes (D1 to D6), a transformer (T1), and an inverter (31). Secondary wirings (N1 to N3) of the transformer supply the induced voltages to a capacitor module (30) composed of sets of two capacitors and two diodes. The capacitors are charged when the diodes included in the capacitor module are conductive. The series electric double-layer capacitor device further comprises voltage adjusting means (32) for changing the DC voltage level between terminals (1, 2), and the inverter converts the voltage-changed DC voltage into an AC voltage. A voltage for canceling the forward voltage drops of the diodes is added to the induced voltages of the secondary wirings by the operation of the voltage adjusting means. The influence of the diodes of when the capacitors are charged is eliminated, and the voltages among capacitors are made uniform.

### TECHNICAL FIELD

The present invention relates to a device connecting electric double-layer capacitors in series, more specifically to a new scheme for solving uneven voltages on such capacitors.

### BACKGROUND OF THE INVENTION

Unlike secondary batteries, electric double-layer capacitors do not accompany with any chemical reaction when charging or discharging, thereby enabling to charge or discharge rapidly and enjoy a long lifetime. By utilizing such advantages, electric storage devices comprising electric double-layer capacitors find wide applications to hybrid automobiles, electrical driven automobiles, emergency power supplies, etc.

Unlike secondary batteries, electric double-layer capacitors exhibit a large voltage change due to charging and discharging. Moreover, since the maximum voltage of an electric double-layer capacitor is low, e.g., approximately 2.5 volts, it is normal to connect a plurality of electrical double-layer capacitors in series in order to provide a battery device. The number of such capacitors may be as large as over 100.

Accordingly, in case of connecting electric double-layer capacitors in series, it is necessary to change the voltage of the entire battery device while keeping voltage balance of each capacitor in order to enhance the utility efficiency of the battery device. For example, if the battery device is rapidly charged in a condition that a voltage on a particular capacitor is higher than that of the others, the charging is restricted only when the voltage of the particular capacitor reaches the maximum tolerable voltage (characteristic degradation starts if the capacitor is over-charged), thereby limiting the maximum energy storage of the battery device. Moreover, since no reverse charging of the electric double-layer capacitor is permitted, the battery device stops discharging when any one of the electric double-layer capacitors discharges to 0 volt.

In order to improve utility efficiency of the battery device, a Patent Document 1 that is listed below proposes a control scheme comprising series connected electric double-layer capacitors and a series connection of switch means and an inductive element connected in parallel with each of the electric double-layer capacitors. When a voltage of a specific electric double-layer capacitor is larger than voltages of the others, a part of charges in the particular electric double-layer capacitor is transferred to the other electric double-layer capacitors for achieving a uniformed voltage on each of the electric double-layer capacitors. Such control is carried out at a selected timing such as, for example, at the start of charging, at the time of full charge, in a middle potential, when charging or discharging, or the like depending on particular applications of such battery device. Alternatively, it is possible to modify the voltage distribution on the capacitors while the battery device is being used.

However, such control scheme requires switching means and an inductive element for each electric double-layer capacitor, thereby making the circuit complicated (less compact) and increasing cost.

On the contrary, it is also proposed to uniform the voltage on each of the electric double-layer capacitors by using a circuit that is operable to all of the series connected electric double-layer capacitors. There are two configurations: one is a fly-back converter configuration and the other is a full-bridge converter configuration.

The fly-back converter configuration is disclosed in a Patent Document 2 and a Non-patent Document 1 that are listed hereinafter.

FIG. 5 is a circuit diagram as disclosed in the Patent Document 2. In this circuit, it is possible to operate a fly-back converter 33 as a DC voltage source including series connected electric double-layer capacitors C1, C2 and C3 by connecting terminals 1 and 18 and terminals 2 and 19. In this manner, currents developed in secondary windings N1, N2 and N3 of a transformer T1 are supplied to respective capacitors C1, C2 and C3 by way of respective diodes D1, D2 and D3, thereby achieving uniformity of the charging voltages on the capacitors C1, C2 and C3.

A switch SW1 of the fly-back converter 33 is turned ON and OFF periodically. When it is ON, the voltage on the series connected electric double-layer capacitors smoothed by a smoothing capacitor 11 is applied to the primary winding N0 of the transformer T1. Since voltages developed in the secondary windings N1, N2 and N3 of the transformer T1 at this time are opposite to the rectifying polarity of the diodes D1, D2, D3, no current flows therein and a current flows only in the primary winding. The energy of this current is stored in the transformer T1 in form of magnetic flux.

Subsequently, when the switch SW1 turns OFF, the transformer T1 generates a counter electromotive force in such a manner to emit the energy that is stored in the transformer T1 in form of magnetic flux. Resulting voltages in the secondary windings N1, N2 and N3 are applied to the respective diodes D1, D2 and D3 in the rectifying direction, thereby supplying charging currents to the respective capacitors C1, C2 and C3. If the voltage on the connected capacitor is lower, an output current in such capacitor becomes larger. As a result, the capacitors C1, C2 and C3 are evenly charged.

On the other hand, in the full-bridge inverter configuration as disclosed in the following Non-patent Document 2, it takes a circuit schematic as shown in FIG. 4. In this circuit, electric double-layer capacitors C1-C6 and diodes D1-D6 constitute capacitor modules 30 by combining C1-C2, D1-D2; C3-C4, D3-D4; and C5-C6, D5-D6. Secondary windings N1, N2 and N3 of a transformer T1 are connected between nodes 3, 5 and 7 of the pair of capacitors and nodes 4, 6 and 8 of the pair of diodes, respectively.

A full-bridge inverter 31 constituting a rectangular voltage generator is connected to a primary winding N0 of the transformer T1. The full-bridge inverter 31 comprises four semiconductor switching devices S1-S4 and feedback diodes D11-D14. The primary winding N0 is connected between a node of the S1-S2 and S3-S4.

The full-bridge inverter 31 generates an inverting polarity rectangular wave voltage by alternately turning ON/OFF the set of switching devices S1-S4 and the set of switching devices S2-S3. The rectangular wave voltage is applied to the primary winding N0 of the transformer T1, thereby inducing similar rectangular wave voltages in the secondary windings N1, N2 and N3.

The rectangular wave voltages developed in the secondary windings N1, N2 and N3 are supplied to one capacitor connected to the diode conducting in this polarity of the two capacitors that are contained in the respective capacitor modules when the rectangular wave voltage is in one polarity. On the other hand, when it is in the opposite polarity, the rectangular wave voltage is supplied to the other capacitor that is connected to the diode conducting in this polarity.

It is to be noted, however, that when the voltage level in the capacitor is higher than the voltage of the secondary winding and the diode connected to such capacitor does not become conducting, no charging takes place. In other words, only capacitors whose voltages are lower than the voltage of the respective secondary winding are selectively charged, thereby balancing the voltages on the capacitors.

As described hereinabove, in the fly-back converter configuration and the full-bridge converter configuration, even if the number of series connected electric double-layer capacitors may increase, it is possible to manage by simply increasing the number of the secondary windings of the transformer and the number of the diodes. In addition, devices that need to be controlled are only several switching devices constituting the full-bridge inverter or the fly-back converter, thereby making the construction easy to control, highly reliable and less expensive.

By comparing the fly-back converter configuration and the full-bridge inverter configuration, they differ in the way of using the transformer. In the fly-back converter, the transformer operates as a current source for the load. On the other hand, in the full-bridge converter, the transformer operates as a voltage source. Moreover, in the fly-back converter, energy is temporarily stored in the transformer in the former half of the switching period and the stored energy is emitted in the latter half of the switching period, it is therefore necessary to increase core capacity. On the contrary, since a high frequency transformer is used in the full-bridge inverter, it is possible to miniaturize the core. And the number of the secondary windings of the transformer may be one half of the number of the capacitors, thereby requiring only one half of the secondary windings in the fly-back converter.

Patent Document 1: JP 7-322491 A

Patent Document 2: JP 3238841

Non-patent Document 1: P. Barrade, “Series Connection of Supercapacitors: Comparative Study of Solutions for the Active Equalization of the Voltages” Electrimacs 2002, 7^{th} International Conference on Modeling and Simulation of Electric Machines, Converters and Systems, 18-21 August, Ecole de Technologie Superieure (ETS), Montreal, Canada

Non-patent document 2: T. Kishi and T. Shimizu, “Studies on Voltage Balancer Circuit for Electric Double-Layer Capacitor”, Electrical Institute of Japan, Materials for Semiconductor Power Conversion Studies, SPC-04-37, 2004

Non-patent Document 3: Y. Takahashi and T. Shimizu, “Voltage Balancer Circuit for Electric Double-Layer Capacitor Using Synchronous Switches”, Lecture Papers 4-041 for Nationwide Convention for Electric Institute of Japan in 2005

### DISCLOSURE OF THE INVENTION

### Problems to be Solved by the Invention

Unfortunately, the full-bridge inverter configuration has the following problems:

Diodes connected to the secondary windings of the transformer prevent the voltages on capacitors from equalizing.

Although there causes no such problem if the forward voltage drop VF of the diodes connected to the secondary windings of the transformer is 0, actual diodes unavoidably have a voltage drop in the range of 0.5-1 volt. It is impossible to charge the respective capacitor if the voltage difference between the voltages on the particular secondary winding and the capacitor connected thereto drops below VF. As a result, voltages between capacitors are not sufficiently equalized even if switching of the full-bridge inverter may be repeated. The effect of VF becomes remarkable when voltages on capacitors drop.

The phenomena will be described hereunder in greater detail with reference to FIG. 2 (a) through (d).

FIG. 2 (a) shows a rectangular wave voltage waveform that is generated from the full-bridge inverter 31 when the voltage across the both ends of the series electric double-layer capacitor device is V in the circuit as shown in FIG. 4. FIG. 2 (b) shows a rectangular wave voltage appearing on each of the secondary windings N1, N2 and N3 when the winding ratio between the primary winding N0 and each of the secondary windings N1, N2 and N3 of the transformer T1 is 2n:1.

Assuming that the forward voltage drop of each of the diodes D1-D6 is VF, the voltage to be applied to the capacitor C1, C3 and C5 when the diodes D1-D6 are ON is as shown by the solid line in FIG. 2 (d), while the voltage to be applied to the capacitors C2, C4 and C6 is as shown by the solid line in FIG. 2 (c). Accordingly, when the voltage on any one of the capacitors C1-C6 is lower than V/(2n)−VF, the corresponding diode becomes ON and the capacitor is charged. On the other hand, when the voltage on a capacitor is higher than V/(2n)−VF, the diode does not become ON, thereby flowing no current for charging the capacitor.

Assuming now that the voltage on the capacitor C1 is lower than V/(2n)−1 as shown in FIG. 2 (d), the capacitor C1 is charged in the latter half cycle of the rectangular wave voltage in the secondary winding N1 when the voltage waveform becomes −V/(2n) in FIG. 2 (b). However, when the voltage on the capacitor C1 becomes higher than V/(2n)−VF as a result of such charging, no further charging takes place, thereby failing to equalize the voltages on the capacitors.

Even if any attempt to compensate for VF by changing the winding ratio a of the transformer, it is impossible to compensate for always constant voltage VF by the secondary windings because the voltage V of the series electric double-layer capacitor device encounters a large change by charging/discharging and the compensation voltage also changes in proportion to the voltage V.

As a solution to such problem, the abovementioned Non-patent Document 3 proposes synchronous rectifiers comprising MOSFETs and a gate driving circuit that replace the diodes. However, this approach requires as many synchronous rectifiers as the number of the capacitors, thereby unavoidably increasing size and cost of the circuit as is the case in the Patent Document 1 and adversely affecting the advantage of the full-bridge inverter configuration that simplifies the circuit.

In order to solve the above problems associated with prior art, it is an object of the present invention to provide a series electric double-layer capacitor device that is simple in construction and is capable of solving unequal voltages among electric double-layer capacitors.

### Means for Solving the Problem

The present invention is a series electric double-layer capacitor device comprising 2n (n being 1 or larger positive integer) electric double-layer capacitors connected in series, 2n diodes, a transformer having a primary winding and n secondary windings, and AC voltage generation means for generating an AC voltage from a DC voltage to be supplied to the primary winding of the transformer, wherein each of the secondary windings of the transformer supplies an induced voltage to respective capacitor module comprising a pair of electric double-layer capacitors and a pair of diodes so that the electric double-layer capacitors included in each of the capacitor module are charged when either one of the diodes included in the capacitor module becomes conducting. It features further provision of voltage adjusting means for converting the voltage level of the DC voltage outputted from the series electric double-layer capacitor device so that the AC voltage generation means converts the DC voltage converted in voltage level by the voltage adjusting means into an AC voltage.

The voltage adjusting means acts to add in advance a voltage to the voltage on each secondary winding for canceling the forward voltage drop of the diode, thereby eliminating adverse effect of the diode while charging the capacitor.

In the series electric double-layer capacitor device according to the present invention, the voltage adjusting means adjusts the voltage level of the DC voltage to be outputted to the AC voltage generation means so that the voltage on each secondary winding of the transformer is equal to VF+V/(2n), wherein V is the output voltage of the series electric double-layer capacitor device and VF is the forward voltage drop of the diode.

The voltage adjusting means adjusts the voltage on each secondary winding of the transformer to the average voltage on the capacitors V/(2n) plus the forward voltage drop of the diode VF.

In the series electric double-layer capacitor device according to the present invention, the winding ratio of the primary winding and each of the secondary windings of the transformer is set to 2n:1 so that the voltage adjusting means outputs to the AC voltage generation means a voltage equal to the output voltage V of the series electric double-layer device plus a constant voltage of 2n×VF.

In this device, the voltage adjusting means can only output a constant voltage (2n×VF) from a battery or the like in addition to the output voltage V even if the output voltage V of the series electric double-layer capacitor device may vary due to charging or discharging.

In the series electric double-layer capacitor device according to the present invention, the voltage adjusting means operates to switch the voltage output of the series electric double-layer device for converting the voltage level and the switching frequency is set higher than the switching frequency of the AC voltage generation means.

Such switching frequency setting prevents fluctuation of the input voltage to the AC voltage generation means and interference with the switching of the voltage adjusting means.

### ADVANTAGES OF THE INVENTION

The series electric double-layer capacitor device according to the present invention is able to equalize the voltage on any one of the series connected capacitors without losing advantage of the full-bridge inverter configuration that simplifies the circuit. The number of components to be added to the circuit of the full-bridge inverter configuration is minimum and there requires a small number of devices to be controlled. As a result, it is possible to achieve compact, less expensive and highly reliable device.

### BRIEF DESCRIPTION OF DRAWINGS

FIG. 1 is a circuit schematic of one embodiment of the series electric double-layer capacitor device according to the present invention;

FIG. 2 shows operation waveforms of one embodiment of the series electric double-layer capacitor device according to the present invention and a conventional device;

FIG. 3 is another voltage adjusting circuit for one embodiment of the series electric double-layer capacitor device according to the present invention;

FIG. 4 is a circuit schematic of a series electric double-layer capacitor of a conventional full-bridge inverter configuration; and

FIG. 5 is a circuit schematic of a series electric double-layer capacitor device of a conventional fly-back converter configuration.

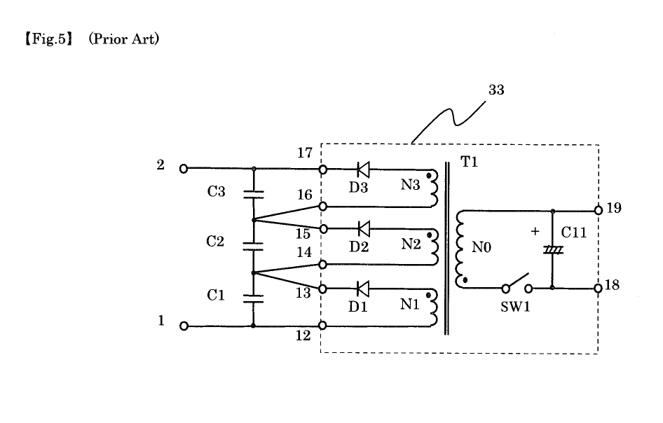

### DESCRIPTION OF REFERENCE NUMERALS

C1-C6 electric double-layer capacitors
C0, C11 smoothing capacitors
L0 reactor
D0-D6 diodes
D11-D14 feedback diodes
T1 transformer
N0 primary winding
N1-N3 secondary windings
S0-S4 switching devices
SW1 switching means
BAT battery
1-13, 21-28 terminals
30 capacitor module
31 rectangular wave voltage generator (full-bridge inverter)
32 variable voltage DC power source
33 fly-back converter

### BEST MODE OF IMPLEMENTING THE INVENTION

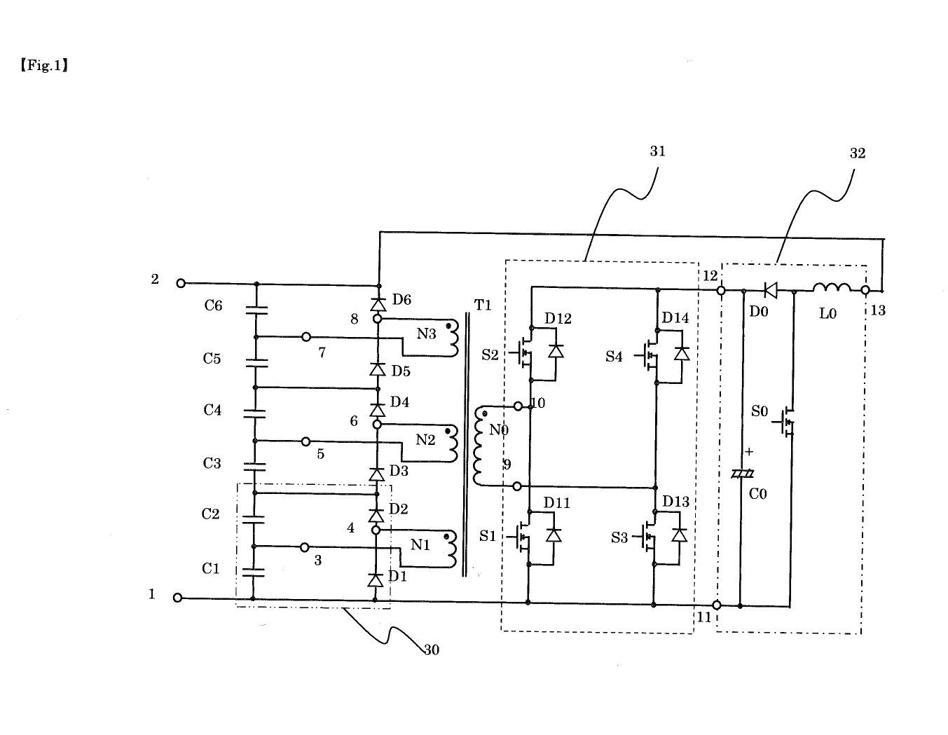

FIG. 1 is a circuit schematic of one embodiment of a series electric double-layer capacitor device according to the present invention.

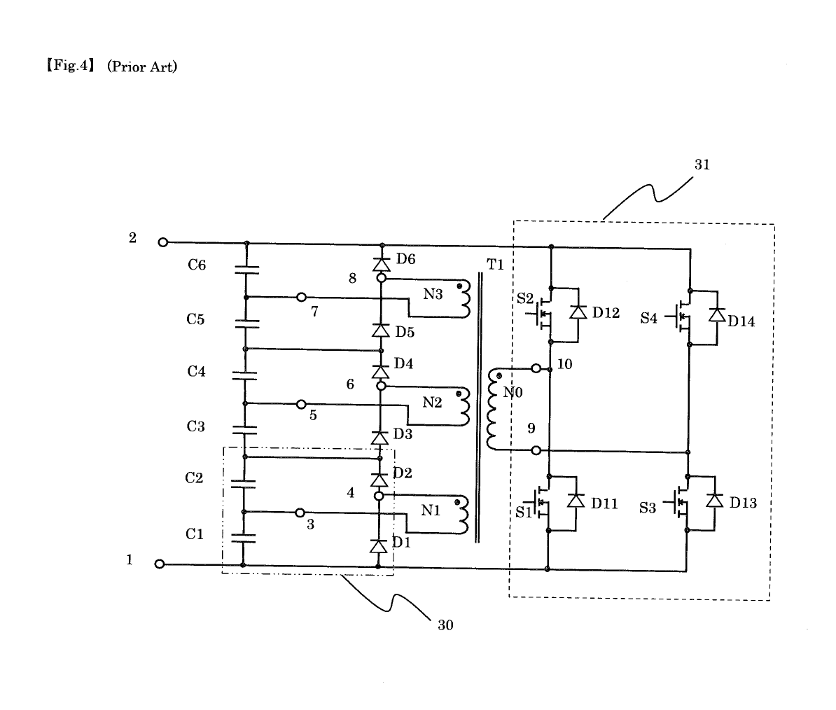

This device comprises series connected electric double-layer capacitors C1-C6, diodes D1-D6 that are connected to the capacitors C1-C6 in one-to-one relationship, a high frequency transformer T1, secondary windings N1, N2 and N3 of the transformer T1 for capacitor modules 30 each comprising a pair of capacitors and a pair of diodes, a primary winding N0 of the transformer T1, four semiconductor switching elements S1-S4 and feedback diodes D11-D14. The device constitutes a full-bridge inverter 31 that generates a rectangular wave voltage to be supplied to the primary winding N0 and a voltage adjusting circuit 32 that steps up the voltage between the capacitors C1-C6 for outputting to the full-bridge inverter 31. In comparison with the circuit in FIG. 4, the circuit differs only in the addition of the voltage adjusting circuit 32.

The voltage adjusting circuit 32 is a voltage step-up chopper that comprises a reactor L0, a diode D0, a semiconductor switching element S0 and a smoothing capacitor C0.

Now, the operation of the device will be described hereunder.

The device is designed for connection to other equipment by way of terminals 1, 2 to act as a battery device. As charging or discharging the other equipment, the terminal voltage V between the terminals 1, 2 may change largely from 100% to about 25%. Moreover, due to variation in capacitance of the capacitors C1-C6, there causes imbalance or un-equality in charging voltage on the capacitors.

At the time of modifying voltage distribution on the capacitors C1-C6, the semiconductor switching element S0 in the voltage adjusting circuit 32 periodically turns ON/OFF the output of the series electric double-layer capacitor device, thereby converting into a predetermined voltage to be outputted to the full-bridge inverter 31.

Now, it is assumed that the voltage adjusting circuit 32 converts the terminal voltage V into a voltage V1 as represented by the following mathematical expression 1:

V1=a×{VF+V/(2n)} (mathematical expression 1)

Where, “a” is the winding ratio of the transformer (number of turns of the primary winding/number of turns of the secondary winding), “VF” is the forward voltage drop of the diodes D1-D6 and “2n” is the number of the electric double-layer capacitors connected in series.

The forward voltage drop VF of the diodes D1-D6 is known and is essentially constant regardless of the applied voltage. However, since the terminal voltage V changes depending upon charging or discharging, it is generally required to detect the terminal voltage V1 and control the output voltage V1 of the voltage adjusting circuit 32 so that the relationship of the (mathematical expression 1) is met.

The full-bridge inverter 31 to which the DC voltage V1 is inputted from the voltage adjusting circuit 32 generates a rectangular wave voltage having the amplitude V1. The transformer T1 having the primary winding N0 to which the rectangular wave voltage is inputted develops in each of the secondary windings N1, N2 and N3 a rectangular wave voltage having the amplitude V2 that is given by the following (mathematical expression 2):

V2=V1/a=VF+V/(2n) (mathematical expression 2)

By adding beforehand the voltage equal to the forward voltage drop VF of the diodes D1-D6 in the voltage developed in each of the secondary windings, if there is a particular one of the capacitors C1-C6 that has a lower voltage than the average voltage V/(2n) of the 2n capacitors, such particular capacitor will be charged. On the contrary, if a capacitor has a higher voltage than V/(2n), the corresponding diode does not become conducting and thus no current flows to charge such capacitor.

As a result, the charging voltage of the capacitors C1-C6 is normalized or equalized with no influence of the diodes D1-D6.

It is to be noted, here, that by assuming a=2n, i.e., by setting the winding ratio a of the transformer T1 to 2n:1 in order to apply a voltage equal to 1/(2n) of the power supply voltage to each of the 2n capacitors connected in series, the voltage adjusting circuit 32 is controlled to provide the output voltage V1 given by the following (mathematical expression 3) regardless of the change in the terminal voltage V:

V1=2n×VF+V (mathematical expression 3)

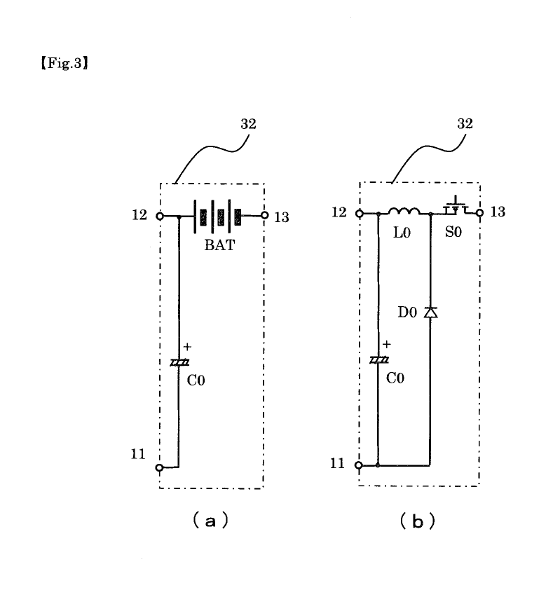

In this case, the voltage adjusting circuit 32 may comprise a battery BAT having the voltage 2n×VF as shown in FIG. 3 (a).

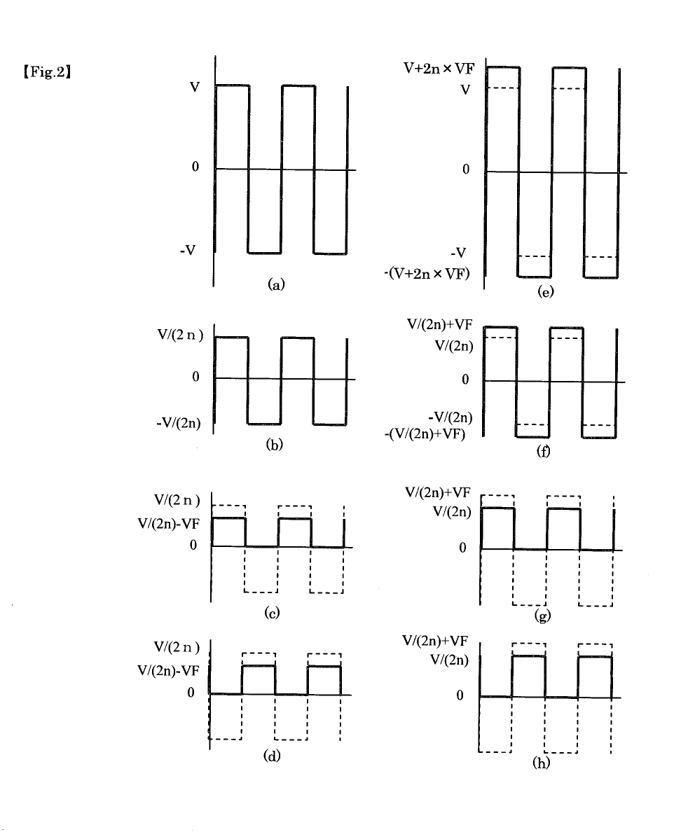

Shown in FIG. 2 (e)-(h) are voltage waveforms on various circuit points. In FIG. 2 (e), the solid line shows the rectangular wave voltage developed by the full-bridge inverter 31 when the terminal voltage of the series electric double-layer capacitor device is V and a=2n in the circuit in FIG. 1. On the other hand, the dotted line shows the (conventional) waveform that is not stepped up by the voltage adjusting circuit 32. The frequency of the rectangular wave is equal to the switching frequency finv of the full-bridge inverter 31.

In FIG. 2 (f), the solid line shows the rectangular wave voltage developed in each of the secondary windings N1, N2 and N3 of the transformer T1, while the dotted line shows the waveform in the conventional circuit.

In FIG. 2 (g), the solid line shows the voltage to be applied to the capacitors C2, C4, . . . , C2n, while the dotted line shows the voltage on the secondary windings.

In FIG. 2 (h), the solid line shows the voltage to be applied to C1, C3, . . . C2n−1, while the dotted line shows the voltage on the secondary windings.

If there is any capacitor Ci among the capacitors C1-C2n whose voltage is lower than the average voltage V/(2n), the diode connected to such capacitor Ci becomes conducting and the voltage V/(2n) is applied to the capacitor Ci for charging it. The capacitor Ci is charged in the half cycle of the full-bridge inverter 31. It is to be noted that since the source of the charging is the capacitors C1-C2n, voltage of the capacitors that are not charged drops. This means that the voltages on the capacitors C1-C2n are gradually normalized or equalized if the full-bridge inverter 31 is operated for a certain time.

Moreover, by choosing the “a” sufficiently smaller than the “2n” in the (mathematical expression 1), the voltage adjusting circuit 32 can be configured by a voltage step-down chopper as shown in FIG. 3 (b).

Since the output V1 from the voltage adjusting circuit 32 is pulsating voltage, it is preferable to employ a smoothing capacitor C0 as shown in FIG. 1. By assuming that the switching frequency of the voltage adjusting circuit 32 is fch, it is not preferable that the input voltage V1 to the full-bridge inverter 31 fluctuates depending upon the output cycle of the voltage adjusting circuit 32 and that the switching of the voltage adjusting circuit 32 and the switching of the inverter 31 interfere with each other. For this end, the switching frequency fch of the voltage adjusting circuit 32 should be set higher than the switching frequency finv of the full-bridge inverter 31 that acts as a rectangular wave voltage generator.

As apparent from the foregoing, the series electric double-layer capacitor device is able to equalize or normalize voltages on capacitors by simple addition of a voltage adjusting circuit comprising a DC chopper, a battery or the like. Even in case of using a DC chopper in the voltage adjusting circuit, it is sufficient to control only a single switching element, thereby making the circuit construction compact and less expensive as compared to a synchronous rectifier for each capacitor and realizing a highly reliable voltage balance circuit.

It is to be noted that the number “n” of the capacitors that are connected in series may be 2 or any number larger than 2. For example, the number “n” may be 100 or more.

### INDUSTRIAL APPLICABILITY

The series electric double-layer capacitor device according to the present invention has a merit of easily equalizing or balancing voltages on the capacitors in a battery device using electric double-layer capacitors. It finds wide applications to hybrid vehicles, electric vehicles, fuel battery vehicles, power storage devices, emergency power supplies, etc.

What is claimed is:

1. A series electric double-layer capacitor device comprising: 2n (n being 1 or larger integer) electric double-layer capacitors connected in series; 2n diodes; a transformer having a primary winding and n pieces of secondary windings; and an AC voltage generation means for generating an AC voltages from a DC voltage for supplying to the primary winding of the transformer, each of the secondary windings of the transformer supplying the induced voltage to each capacitor module comprising a pair of electric double-layer capacitors and a pair of diodes in such a manner that the electric double-layer capacitors included in one capacitor module are charged when each of the diodes included in the capacitor module is conducting,
further comprising a voltage adjusting means for converting the voltage level in the DC voltage outputted from the series electric double-layer capacitor device so that the AC voltage generation means converts the DC voltage converted in the voltage level by the voltage adjusting means into an AC voltage.

2. A series electric double-layer capacitor device of claim 1, wherein the voltage adjusting means adjusts the voltage level of the DC voltage to be outputted to the AC voltage generation means so that the voltage developed in each of the secondary windings of the transformer is equal to VF+V/(2n), where V is the output voltage of the series electric double-layer capacitor device and VF is the forward voltage drop of the diodes.

3. A series electric double-layer capacitor device of claim 2, wherein the winding ratio of the primary winding and each of the secondary windings of the transformer is set to 2n:1 so that the voltage adjusting means outputs to the AC voltage generation means by adding a constant voltage of 2n×VF to the output voltage V of the series electric double-layer capacitor device.

4. A series electric double-layer capacitor device of claim 2, wherein the voltage adjusting means converts the voltage level of the output voltage V by switching the voltage output from the series electric double-layer capacitor device and the switching frequency is set higher than the switching frequency of the AC voltage generation means.
